(19) United States
(12) Patent Application Publication
(10) Pub. No.: US 2010/0300569 A1
(43) Pub. Date: Dec. 2, 2010

(54) CORRUGATED HOSE

(75) Inventors: Christian Degen, Kleinmachnow (DE); Alex Gregorian, Frankfurt (DE); Ralf Siber, Mainz (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/739,126

(22) PCT Filed: Oct. 24, 2008
(86) PCT No.: PCT/EP2008/009034

§ 371 Date: Apr. 21, 2010

(30) Foreign Application Priority Data
Oct. 24, 2007 (DE) 102007050655.6

(51) Int. Cl. F16L 11/11

(52) U.S. Cl. 138/121; 138/119

(57) ABSTRACT

A corrugated hose 10 for carrying a fluid includes, but is not limited to a hose body for carrying the fluid. Furthermore, the corrugated hose includes, but is not limited to at least one circumferential bellows pocket extending radially to the outside in order to make possible movement compensation of the hose body. The hose body in flow direction merges with the bellows pocket via a sharp-edged tear-off edge for detaching the flow from the hose body. By detaching the flow in the tear-off edge it is prevented that the flow flows into the bellows pocket, as a result of which a corrugated hose that is simple to produce and has a low flow resistance is created.

### CROSS-REFERENCE TO RELATED APPLICATIONS

This application is a U.S. National-Stage entry under 35 U.S.C. §371 based on International Application No. PCT/EP2008/009034, filed Oct. 24, 2008, which was published under PCT Article 21(2) and which claims priority to German Application No. 102007050655.6, filed Oct. 24, 2007, which are all hereby incorporated in their entirety by reference.

### TECHNICAL FIELD

The invention relates to a corrugated hose with the help of which fluids, especially gases or liquids, can be carried, wherein the corrugated hose in part is configured in a corrugated shape in order to allow movement compensation.

### BACKGROUND

For example, from DE 29 48 065 A1 a corrugated hose having a substantially cylinder-shaped hose body followed by a plurality of bellows pockets for the movement compensation of the hose body is known. The bellows pockets extend radially to the outside and are embodied circumferentially. In order to optimize the flow in the interior of the corrugated hose, the flanks of the bellows pockets comprise undercut noses oriented towards each other to prevent the carried fluid from flowing into the bellows pocket.

Disadvantageous with such a corrugated hose is that the manufacture of the undercut noses is involved from a manufacturing point of view and therefore expensive and time-consuming.

It is therefore at least one object of the invention to create a corrugated hose that can be simply manufactured and has a low pressure loss. In addition, other objects, desirable features, and characteristics will become apparent from the subsequent summary and detailed description, and the appended claims, taken in conjunction with the accompanying drawings and this background.

### SUMMARY

The corrugated hose according to an embodiment of the invention for the carrying of a fluid comprises a hose body through which the fluid is carried and through which the fluid can flow. Furthermore, the corrugated hose comprises at least one circumferential bellows pocket radially extending outwardly for the movement compensation of the hose body. The hose body merges with the bellows pocket in flow direction via a sharp-edged tear-off edge for detaching the flow from the hose body.

Through the sharp-edged tear-off edge it is avoided that the flow despite a geometry change of the corrugated hose in radial direction flows along the surface of the corrugated hose into the bellows pocket. Instead, the tear-off edge results in a detachment of the flow from the surface of the corrugated hose so that it is possible to dimension the bellows pocket in such a manner that the detached flow is able to again hug the surface of the corrugated hose after it has passed the bellows pocket. In particular it is not necessary to provide undercuts or noses projecting into the bellows pocket in order to largely avoid an increase of the flow resistance through the bellows pockets. Thus, this geometry of the corrugated hose makes possible simple manufacture of the corrugated hose without having to accept increased flow resistance. Tests have shown that the corrugated hose in contrast with comparable corrugated hoses, wherein the bellows pocket is U-shaped with rounded transition regions between the hose body and the bellows pocket has a flow resistance that is reduced by approximately 10%. Furthermore, clearly reduced noise development was measured.

The tear-off edge can more preferably be configured at a right angle, wherein a certain deviation from the right angle can be present without significantly increasing the flow resistance. For forming the tear-off edge the hose body and the bellows pocket can include an angle α of approximately 45°≦α≦135°, more preferably approximately 80°≦α≦120°, preferentially approximately 90°≦α≦110°, particularly preferred approximately 90°≦α≦100°.

In order to avoid damaging the tear-off edge and/or to simplify the manufacture of the tear-off edge the tear-off edge can have a chamfer with a length 1, of approximately 0 mm<1≦3.0 mm, more preferably approximately 0 mm<1≦2.0 mm, preferentially approximately 0 mm<1≦1.0 mm and particularly preferred approximately 0 mm<1≦0.5 mm.

In order to avoid damaging the tear-off edge and/or make possible simple manufacture of the tear-off edge it can additionally be provided that the tear-off edge has a radius R of approximately 0 mm<R≦1.0 mm, more preferably approximately 0 mm<R≦0.75 mm, preferentially approximately 0 mm<R≦0.5 mm, further preferred approximately 0 mm<R≦0.25 mm and particularly preferred approximately 0 mm<R≦0.1 mm.

Preferentially the bellows pocket comprises a transition region located opposite the tear-off edge, wherein the transition region steadily extends in flow direction from a substantially radial orientation to a substantially axial orientation. Through the transition region a gradual transition from the bellows pocket to a following hose body or a further bellows pocket can be achieved, which is substantially embodied without shoulders and without edges. Because of this, the flow detached at the tear-off edge can hug the surface of the corrugated hose without vortices in the transition region. Particularly preferably, the transition region is rounded and more preferably has a radius R1 of approximately 2.0 mm≦R1≦6.0 mm, more preferably approximately 2.5 mm≦R1≦5.0 mm, preferentially approximately 3.0 mm≦R1≦4.0 mm. The transition region thus comprises a simple geometry which can be easily produced.

In a preferred embodiment the bellows pocket comprises a first flank following the tear-off edge which flank is substantially oriented radially. Located opposite the first flank a second flank is provided which is substantially oriented radially. For forming the bellows pocket the first flank and the second flank can be additionally connected with each other via a rounded, more preferably radius-shaped region. The first flank and the second flank have a distance d from each other of approximately 1.5 mm≦d≦6.0 mm, more preferably approximately 1.5 mm≦d≦5.0 mm, preferentially approximately 2.0 mm≦d≦4.0 mm and particularly preferred approximately 2.5 mm≦d≦3.5 mm. This geometry results in a bellows pocket which is large enough to make possible movement compensation of the corrugated hose. On the other hand, the bellows pocket is small enough at the same time so that the flow detached at the tear-off edge cannot flow into the bellows pocket.

Particularly preferably, a plurality of bellows pockets is provided with the corrugated hose whose respective tear-off edges have a distance d from each other, of approximately 5.0 mm≦D≦15.0 mm, more preferably approximately 7.5 mm≦D≦12.5 mm, preferentially approximately 9.0 mm≦D≦12.0 mm and particularly preferred approximately 10.5 mm≦D≦11.5 mm. Through this distance d it is ensured that the flow detached at a previous tear-off edge can again hug the surface of the corrugated hose so that at the next tear-off edge detachment of the flow is achieved again.

The hose body and the at least one bellows pocket can be produced in one piece of a flexible, more preferably rubber-elastic material. On the one hand this makes possible good movement compensation of the corrugated hose and on the other hand results in simpler manufacturability of the corrugated hose, for example through injection molding with a preferentially natural or artificial rubber.

The embodiments of the invention furthermore relate to an internal combustion engine for a motor vehicle having a corrugated hose that can be formed and developed as described above. With the help of the at least one corrugated hose air can be carried to a cylinder of the internal combustion engine so as to be able to combust a fuel in the cylinder. Furthermore, exhaust gas can be carried with the help of such a corrugated hose, which exhaust gas for example is to be carried away from a cylinder in order to discharge the exhaust gas into the environment. In addition, the corrugated hose can be connected with a turbocharger, wherein a corrugated hose each can be connected with the respective inlets and/or outlets of the turbocharger. Furthermore, cooling water can be carried with such a corrugated hose, for example in order to be able to cool the at least one cylinder of the internal combustion engine. Because of the reduced flow resistance of the corrugated hose less power is required for carrying the fluid through the corrugated hose. This results in improved performance and a CO2 reduction of the internal combustion engine.

### BRIEF DESCRIPTION OF THE DRAWINGS

The present invention will hereinafter be described in conjunction with the following drawing figure, where:

FIG. 1 is a schematic sectional view of the corrugated hose according to an embodiment of the invention.

### DETAILED DESCRIPTION

The following detailed description is merely exemplary in nature and is not intended to application and uses. Furthermore, there is no intention to be bound by any theory presented in the preceding background or summary or the following detailed description.

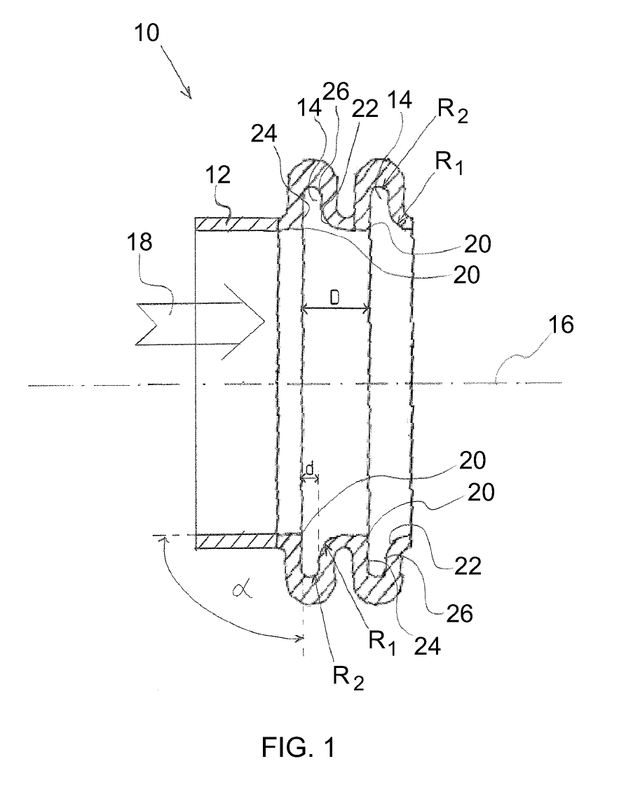

The exemplary corrugated hose 10 shown as a detail in FIG. 1 comprises a hose body 12 which in the exemplary embodiment shown is followed by two bellows pockets 14. The hose body 12 and the bellows pockets 14 are configured rotation-symmetrically to an axis of symmetry 16 so that the bellows pocket 14 extending radially to the outside compared with hose body 12 is embodied circumferentially. In flow direction 18 at the start of the bellows pocket 14 the hose body 12 merges in a sharp-edged manner with the bellows pocket 14 via a tear-off edge 20. For forming the tear-off edge 20 the hose bodies 12 and the bellows pocket 14 include an angle α c=90°.

Located opposite the tear-off edge 20 a transition region 22 is formed which is embodied in a rounded manner and comprises a radius R1 approximately =4.0 mm.

The bellows pocket 14 comprises a radially oriented first flank 24 and a radially oriented second flank 26, which have a distance d approximately=3.0 mm from each other. The first flank 24 and the second flank 26 are connected with each other via a radius R2 approximately=1.5 mm.

The two tear-off edges 20 following in succession have a distance d approximately=11.0 mm from each other.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A corrugated hose for carrying a fluid, comprising:
a hose body adapted to carry the fluid; and
at least one circumferential bellows pocket radially extending to an outside for the movement compensation of the hose body,
wherein
the hose body in a flow direction merges with the at least one circumferential bellows pocket with a sharp-edged tear-off edge adapted to detaching the flow from the hose body.

2. The corrugated hose according to claim 1, wherein the hose body and the bellows pocket for forming the tear-off edge include an angle α of approximately 45°≦+≦135°.

3. The corrugated hose according to claim 1, wherein the tear-off edge comprises a chamfer with a length 1, of approximately 0 mm<1≦3.0 mm.

4. The corrugated hose according to claim 1, wherein the tear-off edge has a radius R of approximately 0 mm<R≦1.0 mm.

5. The corrugated hose according to claim 1, wherein the at least one circumferential bellows pocket comprises a transition region located opposite the tear-off edge and the transition region in a flow direction steadily extends from a substantially radial orientation to a substantially axial orientation.

6. The corrugated hose according to claim 5, wherein the transition region is rounded and has a radius R1 of 2.0 mm≦R1≦6.0 mm.

7. The corrugated hose according to claim 1, wherein the at least one circumferential bellows pocket comprises a first flank substantially oriented radially and following the tear-off edge and a second edge substantially oriented radially and located opposite the first flank, wherein the first flank and the second flank have a distance d from each other of approximately 1.5 mm≦d≦6.0 mm.

8. The corrugated hose according to any one of the claim 1, further comprising a plurality of circumferential bellows pockets comprising tear-off edges having a distance d from each other of approximately 5.0 mm≦D≦15.0 mm.

9. The corrugated hose according to claim 1, wherein the hose body and the at least one circumferential bellows pocket are produced in one piece of a flexible material.

10. (canceled)

11. The corrugated hose according to claim 1, wherein the hose body and the bellows pocket for forming the tear-off edge include an angle α of approximately 80°≦α≦120°.

12. The corrugated hose according to claim 1, wherein the hose body and the bellows pocket for forming the tear-off edge include an angle α of approximately 90°≦α≦110°.

13. The corrugated hose according to claim 1, wherein the hose body and the bellows pocket for forming the tear-off edge include an angle α of approximately 90°≦α≦100°.

14. The corrugated hose according to claim 1, wherein the tear-off edge comprises a chamfer with a length 1, of approximately 0 mm<1≦2.0 mm.

15. The corrugated hose according to claim 1, wherein the tear-off edge comprises a chamfer with a length 1, of approximately 0 mm<1≦1.0 mm.

16. The corrugated hose according to claim 1, wherein the tear-off edge comprises a chamfer with a length 1, of approximately 0 mm<1≦0.5 mm.

17. The corrugated hose according to claim 1, wherein the tear-off edge has a radius R of approximately 0 mm<R≦0.75 mm.

18. The corrugated hose according to claim 1, wherein the tear-off edge has a radius R of approximately 0 mm<R≦0.5 mm.

19. The corrugated hose according to claim 1, wherein the tear-off edge has a radius R of approximately 0 mm<R≦0.25.

20. The corrugated hose according to claim 1, wherein the tear-off edge has a radius R of approximately 0 mm<R≦0.1 mm.

21. The corrugated hose according to claim 5, wherein the transition region is rounded and has a radius R1 of approximately 2.5 mm≦R1≦5.0 mm.

22. The corrugated hose according to claim 5, wherein the transition region is rounded and has a radius R1 of approximately 3.0 mm≦R1≦4.0 mm.

23. The corrugated hose according to claim 1, wherein the at least one circumferential bellows pocket comprises a first flank substantially oriented radially and following the tear-off edge and a second edge substantially oriented radially and located opposite the first flank, wherein the first flank and the second flank have a distance d from each other of approximately 1.5 mm≦d≦5.0 mm.

24. The corrugated hose according to claim 1, wherein the at least one circumferential bellows pocket comprises a first flank substantially oriented radially and following the tear-off edge and a second edge substantially oriented radially and located opposite the first flank, wherein the first flank and the second flank have a distance d from each other of approximately 2.0 mm≦d≦4.0 mm.

25. The corrugated hose according to claim 1, wherein the at least one circumferential bellows pocket comprises a first flank substantially oriented radially and following the tear-off edge and a second edge substantially oriented radially and located opposite the first flank, wherein the first flank and the second flank have a distance d from each other of approximately 2.5 mm≦d≦3.5 mm.

26. The corrugated hose according to any one of the claim 1, further comprising a plurality of circumferential bellows pockets comprising tear-off edges having a distance d from each other of approximately 7.5 mm≦D≦12.5 mm.

27. The corrugated hose according to any one of the claim 1, further comprising a plurality of circumferential bellows pockets comprising tear-off edges having a distance d from each other of approximately 9.0 mm≦D≦12.0 mm.

28. The corrugated hose according to any one of the claim 1, further comprising a plurality of circumferential bellows pockets comprising tear-off edges having a distance d from each other of approximately 10.5 mm≦D≦11.5 mm.

29. The corrugated hose according to claim 9, wherein the flexible material is a rubber-elastic material.
